(19) United States
(12) Patent Application Publication
(10) Pub. No.: US 2018/0349019 A1
(43) Pub. Date: Dec. 6, 2018

(54) MOBILE TERMINAL AND CONTROLLING METHOD THEREOF

(71) Applicant: LG ELECTRONICS INC., Seoul (KR)

(72) Inventors: Sanghyun Eim, Seoul (KR); Jihye Ham, Seoul (KR)

(21) Appl. No.: 15/761,650

(22) PCT Filed: Jan. 27, 2016
(86) PCT No.: PCT/KR2016/000882

§ 371 Date: Mar. 20, 2018

Related U.S. Application Data
(60) Provisional application No. 62/222,212, filed on Sep. 23, 2015.

(30) Foreign Application Priority Data
Nov. 12, 2015 (KR) 10-2015-0158888

(51) Int. Cl. G06F 3/0488; H04M 1/725; G06F 3/0484; G06F 3/0485

(52) U.S. Cl. CPC G06F 3/04883; G06F 3/0485; G06F 3/04845; H04M 1/72519

(57) ABSTRACT

Disclosed are a mobile terminal and controlling method thereof, by which a position of a display region of a video can be automatically adjusted. The present invention includes a wireless communication unit that receives data for playing a video, a display unit that displays the video, and a controller that adjusts the position of a display region of the video in accordance with trace information indicating the position of the display region as a function of the play timing point of the video.

### TECHNICAL FIELD

The present invention relates to a mobile terminal, and more particularly, to a mobile terminal and controlling method thereof. Although the present invention is suitable for a wide scope of applications, it is particularly suitable for automatically adjusting a position of a display region of a video.

### BACKGROUND ART

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

Recently, many ongoing efforts are made to research and develop cameras capable of a multi-view photographing through a plurality of cameras. For instance, if a plurality of cameras are combined together, it is able to photograph a multi-view image having the coverage of 360°. In case of a multi-view image photographed through a plurality of cameras, a different user experience can be provided depending on which part of a video is viewed. For instance, a user having viewed a part of 0°˜180° of a 360° photographed image has an experience totally different that of a user having viewed a part of 180°˜360° of the 360° photographed image despite the same video.

Accordingly, it is necessary to consider a method of providing similar experiences to users who view a multi-view image.

### DISCLOSURE OF INVENTION

### Technical Problem

Accordingly, the present invention is directed to a mobile terminal and controlling method thereof that substantially obviate one or more of the problems due to limitations and disadvantages of the related art.

An object of the present invention is to provide a mobile terminal and controlling method thereof, by which user convenience can be enhanced.

In particular, one object of the present invention is to provide a mobile terminal and controlling method thereof, by which a position of a display region of a video can be automatically adjusted in accordance with trace information.

Another object of the present invention is to provide a mobile terminal and controlling method thereof, by which users are guided to acquire similar experiences by sharing trace information with each other.

Technical tasks obtainable from the present invention are non-limited by the abovementioned technical tasks. And, other unmentioned technical tasks can be clearly understood from the following description by those having ordinary skill in the technical field to which the present invention pertains.

### Solution to Problem

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a mobile terminal according to one embodiment the present invention includes a wireless communication unit that receives data for playing a video, a display unit that displays the video, and a controller that adjusts the position of a display region of the video in accordance with trace information indicating the position of the display region as a function of the play timing point of the video.

To further achieve these and other advantages and in accordance with the purpose of the present invention, as embodied and broadly described, a method of controlling a mobile terminal according to another embodiment of the present invention includes the steps of receiving data for playing a video and displaying trace information indicating a position of a display region as a function of the play timing point of the video, outputting the video through a display unit, and adjusting the position of the display region of the video in accordance with the trace information.

It is to be understood that both the foregoing general description and the following detailed description are exemplary and explanatory and are intended to provide further explanation of the invention as claimed.

### Advantageous Effects of Invention

Accordingly, the present invention provides the following effects and/or features.

First of all, according to one embodiment of the present invention, user convenience can be enhanced.

Secondly, according to one embodiment of the present invention, a position of a display region of a video can be automatically adjusted in accordance with trace information.

Thirdly, according to one embodiment of the present invention, users are guided to acquire similar experiences by sharing trace information with each other.

Effects obtainable from the present invention may be non-limited by the above mentioned effect. And, other unmentioned effects can be clearly understood from the following description by those having ordinary skill in the technical field to which the present invention pertains.

### BRIEF DESCRIPTION OF DRAWINGS

The present invention will become more fully understood from the detailed description given herein below and the accompanying drawings, which are given by illustration only, and thus are not limitative of the present invention, and wherein:

FIG. 1a is a block diagram of a mobile terminal in accordance with the present disclosure;

FIGS. 1b and 1c are conceptual views of one example of the mobile terminal, viewed from different directions;

FIGS. 2a, 2b and 2c are diagrams for one example to describe a multi-view video;

FIGS. 3a and 3b are diagrams for one example of changing a position of a display region;

FIGS. 4a and 4b are diagrams for one example of determining a position of a display region based on an angle;

FIG. 5 is a flowchart for an operation of a mobile terminal according to one embodiment of the present invention;

FIGS. 6a, 6b, 6c and 6d are diagrams for one example of outputting a trace bar;

FIGS. 7a and 7b are diagrams for one example of saving a message;

FIGS. 8a, 8b and 8c are diagrams for one example of outputting a message;

FIGS. 9a, 9b and 9c are diagrams for one example of playing a video according to trace information;

FIG. 10 is a diagram to describe one example of playing a video registered at an SNS account of a prescribed user;

FIGS. 11a, 11b and 11c are diagrams for one example of registering a message;

FIGS. 12a, 12b and 12c are diagrams for one example of sharing trace information;

FIGS. 13a, 13b and 13c are diagrams for one example of registering a reply;

FIGS. 14a, 14b and 14c are diagrams for one example of outputting a message list linked to a prescribed condition met trace information;

FIG. 15 is a diagram for one example of identifiably displaying at least one of a message and an indicator;

FIGS. 16a and 16b are diagrams for one example of outputting preference information;

FIGS. 17a, 17b and 17c are diagrams for one example of playing a video according to trace information;

FIGS. 18a, 18b and 18c are diagrams for one example of outputting a feedback;

FIGS. 19a, 19b and 19c are diagrams for one example of outputting trace information;

FIGS. 20a, 20b, 20c and 20d are diagrams for one example of outputting a message;

FIGS. 21a, 21b, 21c and 21d are diagrams for one example of automatically adjusting a position of a display region centering on a prescribed subject;

FIGS. 22a and 22b are diagrams for one example of raising a preference for a subject included in a video.

FIGS. 23a and 23b are diagrams for one example of outputting a message

FIGS. 24a and 24b are diagrams for one example of preferentially applying trace information of a video sharer; and

FIGS. 25a and 25b are diagrams for one example of applying trace information having a next ordered preference.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

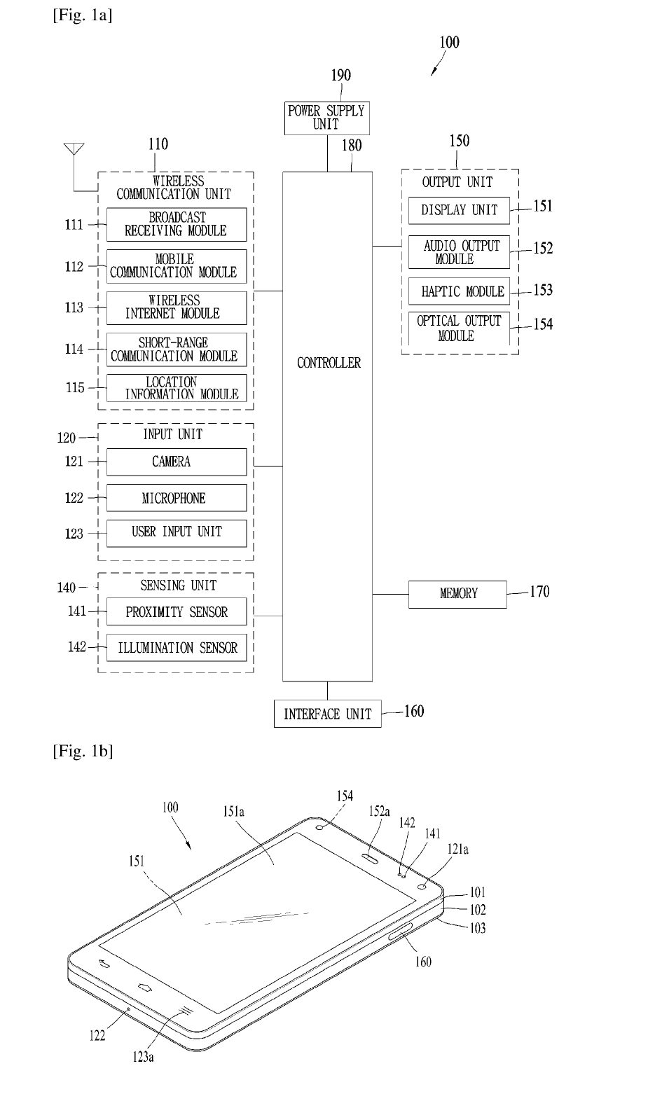

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, informations inputted or outputted through the components mentioned in the foregoing description or runs an application program saved in the memory 170, thereby providing or processing an information or function appropriate for to a user.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components can cooperatively operate to implement operations, controls or controlling methods of a mobile terminal according to various embodiments of the present invention mentioned in the following description. The operations, controls or controlling methods of the mobile terminal can be implemented on the mobile terminal by running at least one application program saved in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a unibody is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be equipped with the display unit 151, the 1st audio output unit 152a, the 2nd audio output unit 152b, the proximity sensor 141, the illumination sensor 142, the optical output unit 154, the 1st camera 121a, the 2nd camera 121b, the 1st manipulating unit 123a, the 2nd manipulating unit 123b, the microphone 122, the interface unit 160, and the like.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160.

Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

For clarity and convenience of the following description, assume that a mobile terminal 100 mentioned in the following description includes at least one of the components shown in FIGS. 1A to 1C. For instance, assume that a mobile terminal according to the present invention includes the wireless communication unit 110, the sensing unit 140, the display unit 151, the memory 160 and the controller 180.

According to embodiments mentioned in the following description, assume that the display unit 151 is embodied into a touchscreen. In particular, the touchscreen operates as an output device configured to output information and is also able to operate as an input device configured to receive user's touch input.

A mobile terminal according to the present invention can play a video made through a camera or a video received form an external environment. In this case, the video played by the mobile terminal may include a multi-view video made using a plurality of cameras.

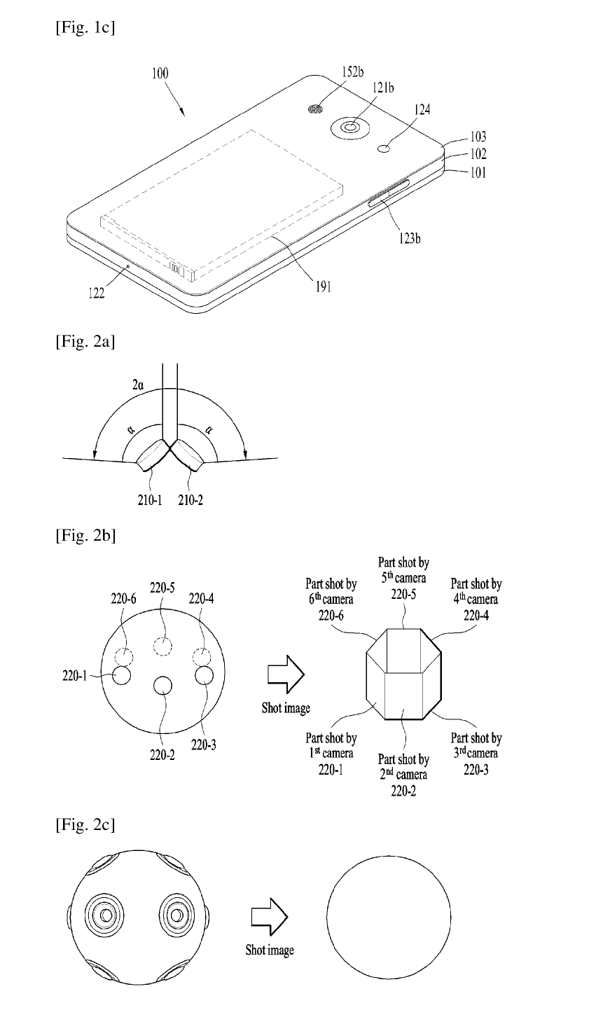

FIG. 2 is a diagram for one example to describe a multi-view video. In case that a plurality of cameras are provided to a mobile terminal, it is possible to perform a shoot of which view angle is wider than that of a case of a single camera provided to a mobile terminal. For instance, like the example shown in FIG. 2 (a), if two cameras 210-1 and 210-2, each of which view angle is α, are used, it may bring the same effect in using a camera of which maximum view angle is 2α.

If the number of cameras is incremented, it may bring the same effect as having a camera of which view angle is 360° centering on a prescribed axis. For instance, like the example shown in FIG. 2 (b), if a plurality of cameras 220-1 to 220-6 are disposed in a ring shape, it may bring the same effect as having a camera of which view angle is 360° centering on a prescribed axis. Images obtained through a plurality of the cameras shown in FIG. 2 (b) can be logically schematized into a cubic figure. For instance, images photographed through 6 cameras can be schematized into a cylindrical shape or a hexagonal pillar shape. In FIG. 2 (b), images photographed through a plurality of cameras are schematized into a hexagonal pillar shape. In this case, lateral faces of the hexagonal pillar may be regarded as corresponding to the images photographed through a plurality of the cameras, respectively.

Like the example shown in FIG. 2 (b), if a plurality of the cameras are disposed in the ring shape, it is able to acquire omni-directionally photographed images with reference to a single center axis. If the number of the cameras is further incremented, it may be able to acquire omni-directionally photographed images with reference to each of a plurality of center axes. Like the example shown in FIG. 2 (c), if cameras are disposed in a globular shape, images acquired through a plurality of cameras can be logically schematized into a polyhedral or globular shape. Referring to FIG. 2 (c), images photographed through a plurality of cameras are schematized into a globular shape.

While a video is played, the controller 180 may control a partial region of the video to be outputted through the display unit 151. While the partial region of the video is outputted, if a prescribed user input is received, the controller 180 can change a position pf a region outputted through the display unit 151.

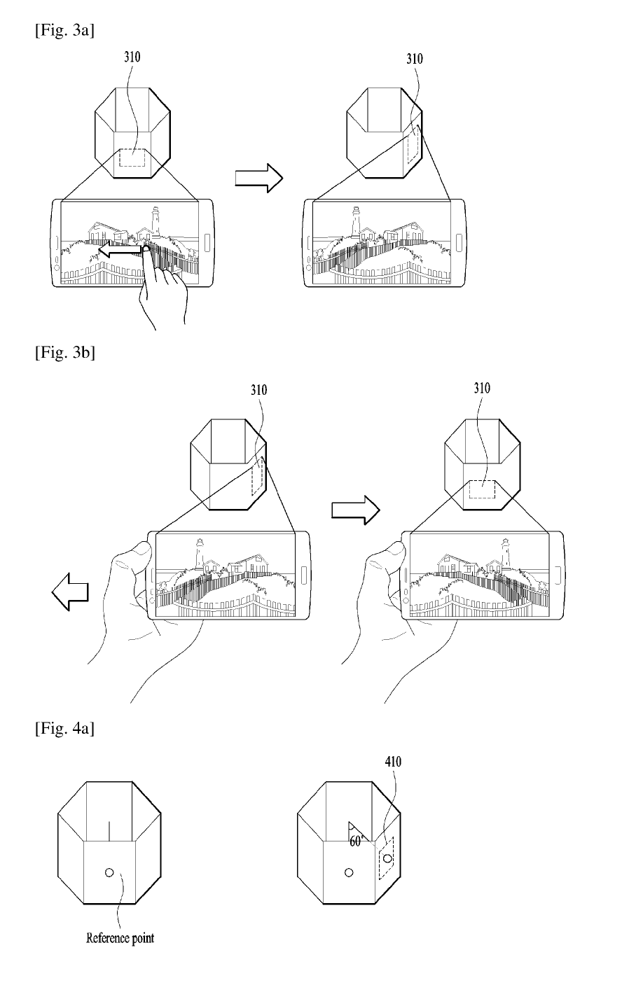

For instance, FIG. 3 is a diagram for one example of changing a position of a display region. For clarity of the following description, assume that a whole region of a video is in a state capable of being logically schematized into a hexagonal pillar shape like the example shown in FIG. 2 (b).

Referring to FIG. 3, while apportion of a video is displayed, if a prescribed user input is received, the controller 180 can change a position of a display region. In particular, while a portion of a video is displayed, if a user input applied in a manner that a pointer currently touching the display unit 151 is dragged to move in a prescribed direction is received, the controller 180 can control a display region 310 to move in a direction opposite to the drag moving direction of the pointer (or, in the drag moving direction of the pointer). For instance, referring to FIG. 3 (a), the display region 310 has moved in the direction opposite to the drag moving direction of the pointer.

While a portion of a video is displayed, if a gesture of moving the mobile terminal in a prescribed direction is sensed, the controller 180 can control a display region 310 to move in a moving direction of the mobile terminal (or, in a direction opposite to the moving direction). For instance, referring to FIG. 3 (b), the display region 310 has moved in the same moving direction of the mobile terminal.

A position of a region (hereinafter named ‘display region’) outputted through the display unit 151 in a whole region of a video can be defined by an angle.

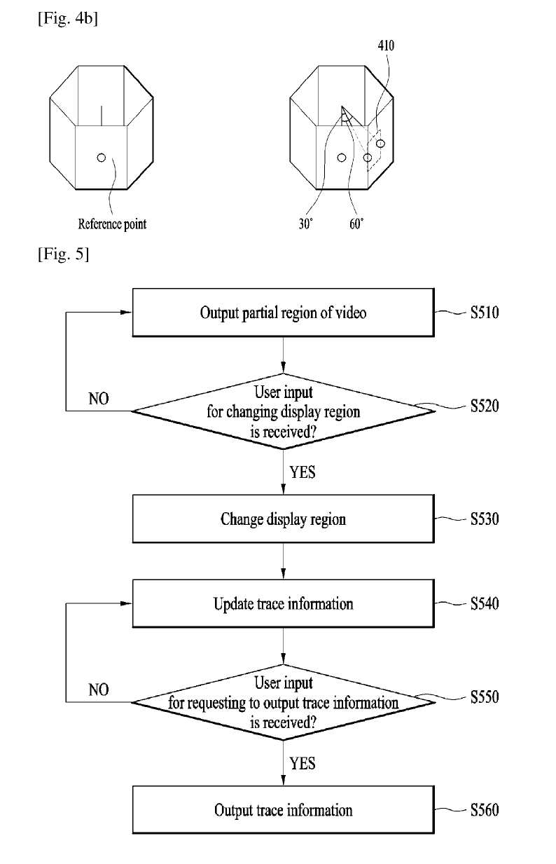

For instance, FIG. 4 is a diagram for one example of determining a position of a display region based on an angle.

For clarity of the following description, assume that a video is in a state capable of being schematized into a hexagonal pillar like the former example shown in FIG. 2 (b).

When a random point in a whole region of a video is set as a reference point (i.e., a point having an angle set to zero), a position of a display region can be defined as a rotating angle from the reference point to a prescribed point (e.g., a center point of the display region) included in the display region.

For instance, if a display region 410 has a rotating angle of 30°, as shown in FIG. 4 (a), it may mean that a position of the display region 410 is set to include a point rotated by 60° from a reference point.

When a random point in a whole region of a video is set as a reference point, the display region 410 can be defined as a rotating angle against each side.

For instance, if the display region 410 has rotating angles 30° and 60°, like the example shown in FIG. 4 (b), it may mean that one side in the display region 410 is set to be located at a point rotated from a reference point by 30° and that another side in the display region 410 is set to be located at a point rotated from the reference point by 60°.

For clarity of the following description, an angle value indicating a position of a display region shall be named ‘display angle’.

Based on the above description, a mobile terminal according to the present invention shall be described in detail as follows.

FIG. 5 is a flowchart for an operation of a mobile terminal according to one embodiment of the present invention. For clarity of the following description, assume that a partial region of a video is currently displayed through the mobile terminal.

Referring to FIG. 5, the controller 180 can save a trace information indicating a change history of a display region during a video playback. For instance, while a partial region of a video is outputted [S510], if a user input for changing a display region is received [S520], the controller 180 changes the display region in response to the user input [S530] and is able to save a trace information, which indicates that the display region has been changed at a specific timing point, in association with the video [S540].

If a prescribed user input is received [S550], the controller 180 can control a trace bar, which visualizes the trace information of the video, to be outputted [S560].

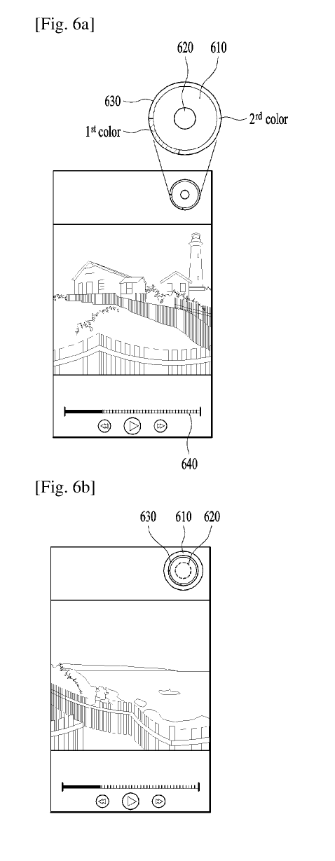

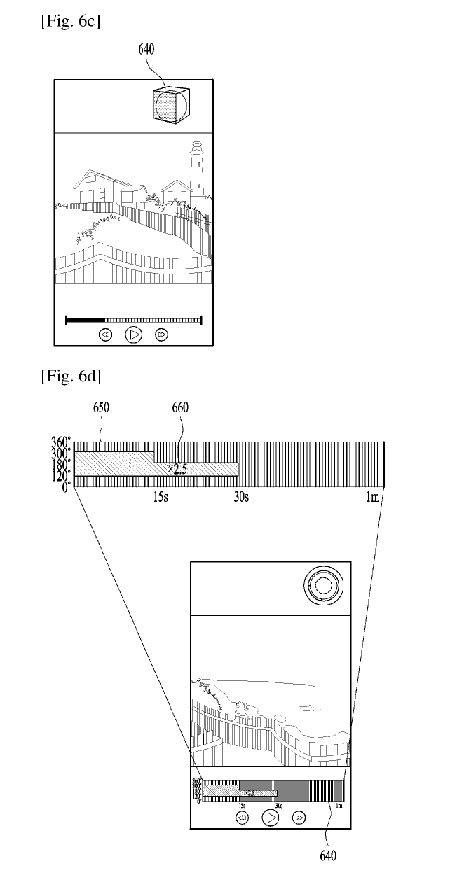

For instance, FIG. 6 is a diagram for one example of outputting a trace bar.

Referring to FIG. 6, if a partial region of a video is outputted through the display unit 151, the controller 180 can control an indicator 610, which indicates an outputted region in a whole region of the video, to be outputted. In this case, the indicator 610 may have a planar figure or a 3-dimensional (3D) figure depending on a type of the video.

For instance, if a video made through a plurality of cameras is currently played, as shown in FIG. 2 (b) and FIG. 2 (c), the controller 180 can control the indicator 610 in shape of a hexagonal pillar, a cylinder, a polyhedron, or a globe to be outputted. According to the example shown in FIG. 6 (a), the indicator 610 is in shape of the globe.

An object 620 indicating a position of a currently outputted region (i.e., a display region) can be outputted on the indicator 610. If the position of the display region is changed, the controller 180 can control a position of the object 620 on the indicator 610 to be changed.

In case that the indicator 610 has the shape of a #D figure, it is necessary to distinguish whether the object 620 indicates a front part of the 3D figure or a backside part of the 3D figure. In particular, using a color, transparency, shape, size and/or the like of the object 620, the controller 180 can distinguish whether the object 620 indicates a front part of the 3D figure or a backside part of the 3D figure. For instance, if the object 620 has a 1st color, it may be appreciated that the object 620 indicates the front part of the globe. If the object 620 has a 2nd color, it may be appreciated that the object 620 indicates the backside part of the globe.

Yet, for clarity of the description, in case that an outline of the object 620 is a solid line, assume that the object 620 indicates the front part of the globe. And, in case that an outline of the object 620 is a dotted line, assume that the object 620 indicates the backside part of the globe.

In accordance with a zooming level, the controller 180 can adjust a size of the indicator 610. For instance, if the video is enlarged, the controller 180 controls the size of the indicator 610 to increase. For instance, if the video is reduced, the controller 180 controls the size of the indicator 610 to decrease.

A time line bar 630 to indicate a current play timing point of the video may be outputted around the indicator 610. In doing so, the time line bar 630 may be configured to enclose the indicator 610. Assuming that a total length of the indicator 610 indicates a total play quantity, the controller 180 can indicate a current play timing point by differentiating a color of the time line bar 630 before and after the current play timing point. Referring to FIG. 6 (a), an interval previous to the current play timing point is outputted in a 1st color, while an interval next to the current play timing point is outputted in a 2nd color, for example.

Instead of outputting the time line bar 630, the controller 180 can control a progress bar 640, which indicates a current play timing point of the video, to be outputted on the video. Alternatively, the controller 180 may control both of the time line bar 630 and the progress bar 640 to be simultaneously outputted. According to the example shown in FIG. 6 (a), both of the time line bar 630 and the progress bar 640 are simultaneously outputted.

While the video is displayed, if a prescribed user input is received, the position of the display region may be changed. In case that the position of the display region is changed, the controller 180 can control a position of the object 620 on the indicator 610 to be changed. For instance, referring to FIG. 6 (a) and FIG. 6 (b), the object 620 has moved away from the front part of the globe into the backside part of the globe.

In accordance with a zooming level of the video, the controller 180 can adjust a size of the indicator 610. For instance, if the video is enlarged to be greater than a reference value, the controller 180 can control the size of the indicator 610 to increase. For instance, if the video is reduced to be smaller than the reference value, the controller 180 can control the size of the indicator 610 to decrease. According to the example shown in FIG. 6 (a) and FIG. 6 (b), as the video is enlarged to be greater than the reference value, the size of the indicator 610 increases.

With reference to the time line bar 630, the controller 180 can adjust a size of the indicator 610 in accordance with a zooming level. For instance, if the video is not in an enlarged or reduced state, as shown in FIG. 6 (a), the controller 180 can adjust the size of the indicator 610 in a manner that the indicator 610 comes in contact with a boundary of the time line bar 630. On the other hand, if the video is in the enlarged state, as shown in FIG. 6 (b), the controller 180 can adjust the size of the indicator 610 in a manner that the indicator 610 overpasses the boundary of the time line bar 630. Besides, if the video is in the reduced state, the controller 180 may control the size of the indicator 610 in a manner that the indicator 610 is situated inside the time line bar 630 [not shown in the drawing].

The indicator may have a shape different to those shown in FIG. 6 (a) and FIG. 6 (b). For instance, like the example shown in FIG. 6 (c), the controller 180 may configure an indicator 640 in a manner of combining a globe with a hexahedron configured to enclose the globe. The controller 180 can control at least one face of a hexahedron corresponding to a current display region to be identifiably displayed on behalf of an object. According to the example shown in FIG. 6 (c), one face of the hexahedron is outputted in color different from that of the rest of the hexahedron.

Referring to FIG. 6 (c), the controller 180 can adjust a size of the globe in accordance with a zooming level. For instance, if the video is enlarged to be equal to or greater than a reference value, the controller 180 can control the size of the globe in a manner that the globe overpasses boundaries of the respective faces of the hexahedron. If the video is not in the enlarged or reduced state, the controller can control the size of the globe in a manner that the globe comes in contact with the respective faces of the hexahedron.

While the video is played, if a prescribed user input is received, the controller 180 can control a trace bar 650, which visualizes a trace information, to be outputted. For instance, in response to one of a touch input of touching an indicator, a user input of dragging a pointer currently touching a progress bar to a prescribed region, a user input of dragging an indicator onto a progress bar, and the like, as shown in FIG. 6 (d), the controller 180 can control the trace bar 650, to be outputted. The trace bar 650 may include a graph configured in a manner that one axis indicates a play timing point of a video and that the other axis indicates a display angle. Based on a position of a display region per play timing point of a video, the controller 180 can configure the trace bar 650.

For instance, the trace bar 650 shown in FIG. 6 (d) indicates that a display region having a display angle correspond to 120°˜180° is outputted from an initial play timing point of the video to 15 seconds and also indicates that a display region having a display angle correspond to 120°˜300° is outputted from 15 seconds to 30 seconds.

A zooming information may be outputted to the trace bar 650. For instance, if a video is enlarged or reduced during a video play, the controller 180 can control a zooming information of the video to be outputted onto the trace bar 650. For instance, referring to FIG. 6 (d), when a view of the video corresponding to 15 seconds of the video is played, the video is enlarged by ×2.5.

Through the trace bar 650, a user can obtain such information as current play timing point, position of current display region, and the like. Hence, while the trace bar 650 is outputted, the controller 180 may not output the indicator 610 and the time line bar 630, of which functions are redundant with the trace bar 650. Thus, if the outputs of the indicator 610 and the time line bar 630 are omitted, the controller 180 stops outputting the trace bar 650 and may resume the outputs of the indicator 610 and the time line bar 630, in response to a prescribed user input (e.g., a user input of dragging to move a pointer currently touching the trace bar 650 in a prescribed direction, etc.).

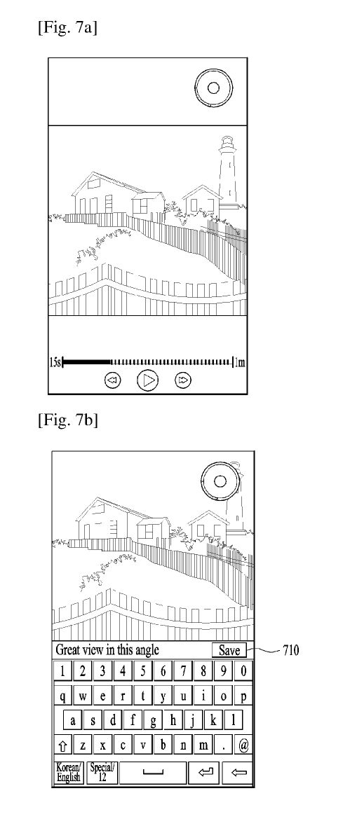

A user can save a message during a video play. In doing so, the message can be saved in association with a time information indicating a time, at which the message will be outputted, and a location information indicating a location to which the message will be outputted. One example of saving a message is described in detail with reference to FIG. 7 as follows.

FIG. 7 is a diagram for one example of saving a message.

Referring to FIG. 7, while a video is played, if a user input for inputting a message is received, like the example shown in FIG. 7 (a), the controller 180 can control an input device (e.g., an input method editor (IME)) for inputting a message to be outputted. While the input device is outputted, the controller 180 may pause the play of the video. Instead, the controller 180 may control the video to be continuously played while the input device is outputted. Yet, in order to prevent the input device from blocking the video, the controller 180 can control the input device and the video to be displayed on positions failing to overlap each other.

After a text has been inputted through the input device, if a user input (e.g., a touch input of touching a button ‘save’ shown in FIG. 7 (b)) for saving the inputted text is received, the controller 180 can save a corresponding message.

In doing so, the controller 180 can set an output timing point of the message and an output position of the message. In particular, the output timing point indicates a timing point at which the message is outputted in a total play interval of the video. And, the output position indicates a position to which the message will be outputted in a whole region of the video.

The output timing point may be set to a play timing point of the video on saving the message. And, the output position may be set to correspond to a position of at least one partial region included in a display region on adding the message. For instance, like the example shown in FIG. 7 (b), if the message is saved on outputting a view of the video corresponding to 15 seconds, an output timing point of the message can be set to 15 seconds. If the message is saved when an angle of the display region is 30°˜60°, an output position of the message may have a range between 30° and 60° in accordance with a corresponding length.

Thereafter, if the message added video is played, the controller 180 may determine whether to output the message in consideration of the output timing point of the message and the output position of the message.

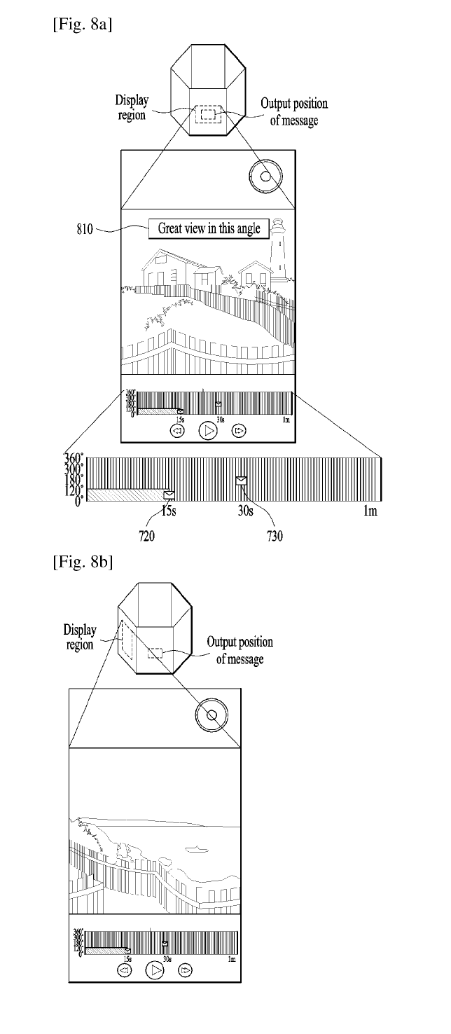

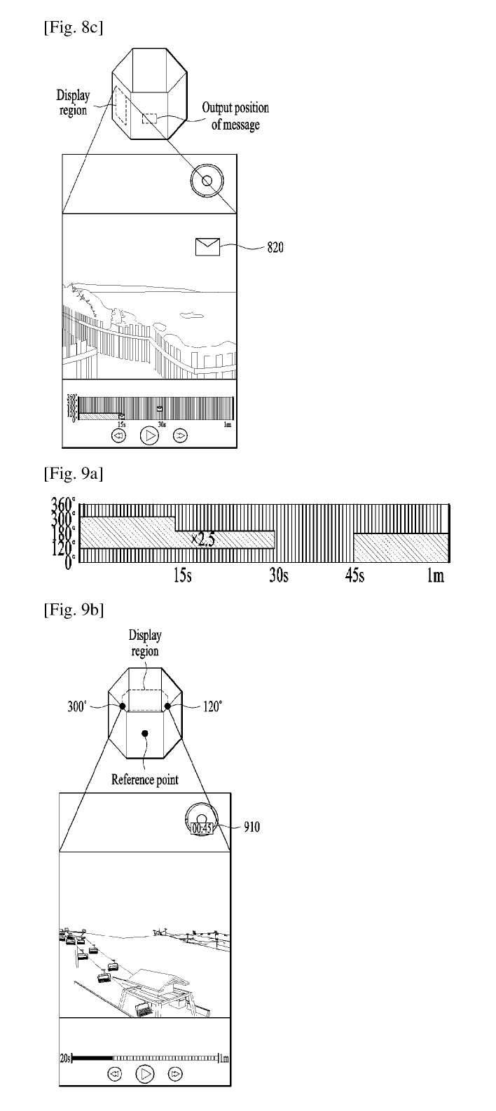

FIG. 8 is a diagram for one example of outputting a message.

Referring to FIG. 8, when a current timing point of a video nearly arrives at an output timing point of a message or before the current play timing point of the video reaches a prescribed time expiring from the output timing point of the message, if a position of a display region includes an output position of the message, the controller 180 can control the message to be outputted.

For clarity of the description, assume that a video is schematized into a hexagonal pillar, that an output timing point of a message is set to 15 seconds, and that the message is set to be outputted between 10° and 20° with reference to a prescribed reference point.

When a current play timing point of a video becomes 15 seconds or before the current play timing point of the video corresponds to a prescribed time expiring from 15 seconds, like the example shown in FIG. 8 (a), if a display region is set to include at least one portion between 10° and 20°, the controller 180 can control at least one portion of a message 810 to be outputted.

On the other hand, When a current play timing point of a video becomes 15 seconds or before the current play timing point of the video corresponds to a prescribed time expiring from 15 seconds, like the example shown in FIG. 8 (b), if a display region is not situated between 10° and 20°, the controller 180 can control a message not to be outputted.

For another instance, if a display region fails to include an output position of a message, the controller 180 can control an indicator 820, which indicates that a registered message 810 exists, to be outputted. For example, referring to FIG. 8 (c), the indicator 820 indicating that the message 810 exists is outputted. If a user input of touching the indicator 820 is received, the controller 180 can adjust a position of the display region to include the output position of the message. Hence, by a touch input of touching the indicator 820, the message may be outputted. For another example, if a user input of touching the indicator 820 is received, the controller 180 fixes the position of the display region and is also able to control the message to be outputted.

Like the example shown FIG. 8, only if a current play timing point of a video and a position of a display region meet a message output timing point condition and a message output position condition, the controller 180 can output the message.

The controller 180 can display an output timing point of a message and an output position of the message on a trace bar. For example, referring to FIG. 8 (a), outputted are an indicator 720 indicating that a message is added to a point corresponding to 15 seconds and 10°˜30° and an indicator 720 indicating that a message is added to a point corresponding to 30 seconds and 120°˜180°. Besides, if a play timing point of a video reaches 30 seconds and a position of a display region includes a range between 120° and 180°, a message saved at a corresponding position may be outputted through the display unit 151 [not shown in the drawing].

The controller 180 can save a trace information together with a video. If it is intended to share the video with a different terminal, the trace information associated with the video can be shared as well. For example, if it is set to share a video with a different terminal, the controller 180 may transmit/receive a trace information associated with the video to/from the different terminal.

By applying a trace information saved in association with a video, the controller 180 can control the video to be played. In particular, based on the trace information, the controller 180 can automatically adjust a position of a display region per play timing point.

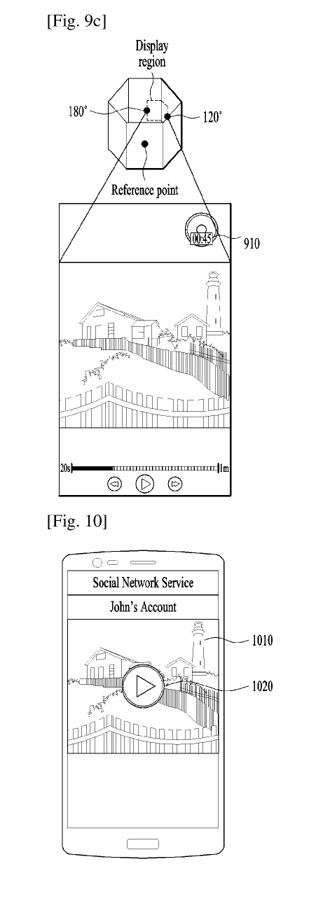

FIG. 9 is a diagram for one example of playing a video according to trace information. For clarity of the description, assume that the trace information is the same as shown in FIG. 9 (a).

Referring to FIG. 9, if a user input for playing a video in accordance with a trace information is received, the controller 180 can play the video in accordance with the trace information. For example, if the trace information indicates that a display angle is 120°˜300° in an interval between 0 and 15 seconds and that a display angle is 120° ˜180° between 15˜30 seconds, the controller 180 controls a display region, of which display angle corresponds to 120°˜300°, to be outputted in the interval between 0 and 15 seconds and is also able to control a display region, of which display angle corresponds to 120°˜180°, to be outputted in the interval between 15 and 30 seconds.

For example, referring to FIG. 9 (a), since a current play timing point of a video is 10 seconds, a display region may be set at a position having a display angle of 120°˜300°. For example, referring to FIG. 9 (b), since a current play timing point of a video is 20 seconds, a display region may be set at a position having a display angle of 120°˜180°.

If there is an interval (e.g., a skipped interval without being played) having not trace information exist in a video, the controller 180 can skip the interval having no trace information exist therein. Regarding the trace information shown in FIG. 9 (a), since the trace information does not exist between 30˜45 seconds, the controller 180 may be able to skip a play in an interval between 30˜45 seconds.

The controller 180 can control a total play time information, which is consumed for playing a video in accordance with a trace information to be outputted. For example, in case of playing a video in accordance with a trace information shown in FIG. 9 (a), a consumed total play time may amount to 45 seconds (i.e., a play in an interval between 30˜45 seconds in a video amounting to total 1 minute is skipped). Referring to FIG. 9 (a) and FIG. 9 (b), outputted on an indicator is a total play time information 910 on a time consumed for playing a video in accordance with a trace information.

While a video is played in accordance with a trace information, if a user input of touching a video play screen or a user input for changing a position of a display region is received, the controller 180 may stop playing the video in accordance with the trace information.

In case of a multi-view video, a difference in user experience may be generated depending on whether a prescribed part in a whole region of a video is viewed. For example, when a video is schematized into a globular shape, a user having viewed a video centering on a front part of a globe and a user having viewed the video centering on a backside part of the globe have different experiences, respectively. Yet, if a video is played in accordance with a trace information shared by a trace information sharing, it is advantageous in that users can have a unified experience.

In case of playing a video through a prescribed wen service, trace information may be shared between web service users. In this case, the web service may include one of various kinds of services (e.g., SNS (social network service), VOD (video on demand) service, a video streaming service, etc.) for providing video streaming. For clarity of the description of the embodiments described in the following, assume that a web service includes SNS and that a video can be played by streaming through a communication with an SNS server.

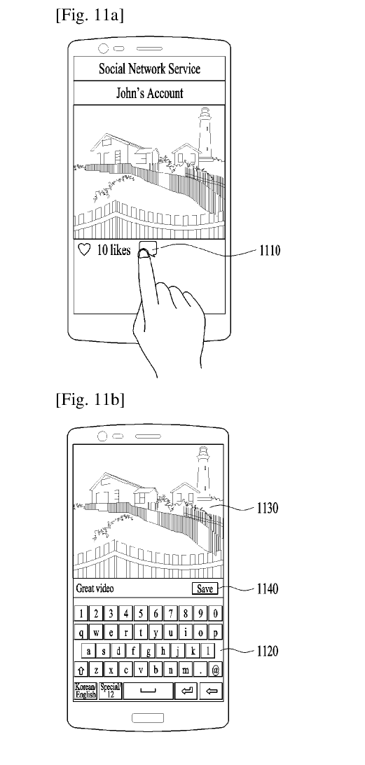

FIG. 10 is a diagram to describe one example of playing a video registered at an SNS account of a prescribed user.

Referring to FIG. 10, if an SNS account of a prescribed user is accessed, posts registered at the SNS account can be outputted. In doing so, if the post includes a video, the controller 180 can control a preview image of the video included in the post and at least one button, which is provided to trigger a video play, to be outputted.

For instance, FIG. 10 shows that a play button 1020 is outputted by overlaying a preview image 1010.

If a user input of touching the play button 1020 is received, the controller 180 can play the video. In response to a user input for changing a position of a display region, the controller 180 can change a position and size of the display region.

A user can register a message at a post. For example, during a video play or after completion of the video play, if a text is inputted, the controller 180 can control the inputted text to be registered at the post. In this case, the message may have a link with which a trace information applied during the video play is associated.

For instance, FIG. 11 is a diagram for one example of registering a message.

Referring to FIG. 11, while a video is played, if a user input (e.g., a touch input of touching a message adding button 1110 shown in FIG. 11 (a)) for composing a new message is received, like the example shown in FIG. 11 (b), the controller 180 can control an input device (e.g., IME) 1120 to be outputted. While the input device 1120 is outputted, the controller 180 may pause a play of a video 1130. Alternatively, while the input device 1120 is outputted, the controller 180 may control the video 1130 to be continuously played. Yet, in order to prevent the input device 1120 from blocking the video 1130, the controller 180 can control the input device 1120 and the video 1130 to be displayed at positions failing to overlap each other, respectively.

After a text has been inputted through the input device, if a user input (e.g., a touch to a save button 1140 shown in FIG. 11 (b)) for registering the inputted text as a message is received, the controller 180 can make a request for a registration of the message for a post including a video to an SNS server.

In doing so, the controller 180 can make a request for a registration of a trace information applied during a video play to the SNS server 180 as well. If the video is not played to an end yet, the controller 180 may request the SNS server to register the trace information amounting to a current play timing point.

Having received a message 1150 and a trace information from the mobile terminal, the SNS server registers the message 1150 and is also able to control the received trace information to be linked to the message 1150. In order to identify the trace information linked message 1150, the SNS server may provide an indicator 1160 configured to identify the trace information linked message 1150. For example, referring to FIG. 11 (c), together with the message 1150, the indicator 1160 indicating that the trace information is linked to the message 1150 is outputted. In FIG. 11 (c), the indicator 1160 is represented in an elliptical shape, by which a shape of an indicator is non-limited.

After the message 1150 has been registered at the SNS server, if the video play continues, the controller 180 may request for an update of the trace information, which is linked to the message 1150, to the SNS server. Based on the updated trace information received from the mobile terminal, the SNS server can update the trace information linked to the message 1150.

Besides, if a trace information linked to a message opens out to match a prescribed subject appearing in a video, the controller 180 may be able to use an image of the prescribed subject as an indicator [not shown in the drawing]. Hence, a user may be able to recognize that the trace information linked to the message opened out centering on the prescribed subject appearing in the video.

A message registered at a post may be used in sharing trace information between users. For example, if a user input of touching a message or an indicator is received, the controller 180 can play a video in accordance with the registered trace information.

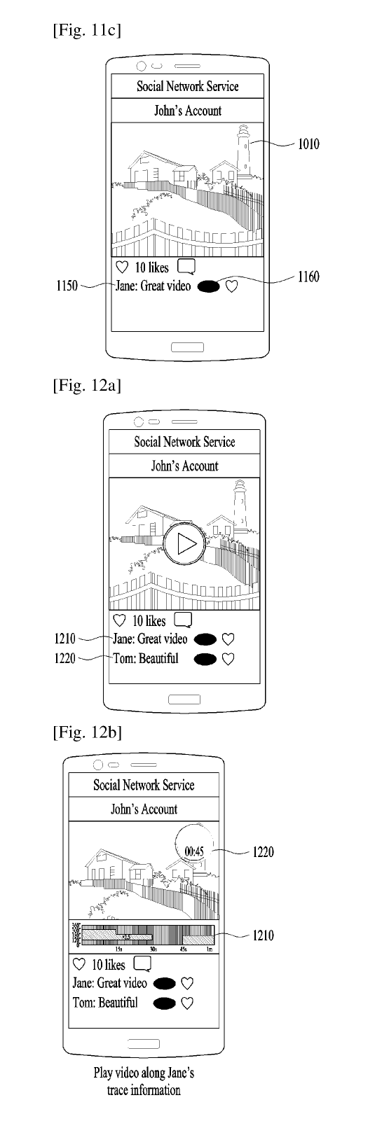

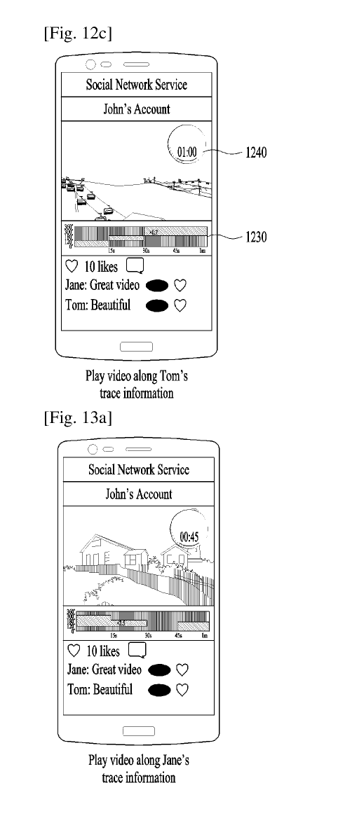

For instance, FIG. 12 is a diagram for one example of sharing trace information. For clarity of the description, like the example shown in FIG. 12 (a), assume that a message of a 1st user (e.g., Jane shown in FIG. 12 (a)) and a message of a 2nd user (e.g., Tom shown in FIG. 12 (a)) are already registered at a post including a video.

Referring to FIG. 12, while a post including a video is outputted, if a user input of touching a message registered by a 1st user or an indicator indicating a trace information of the 1st user is received, the controller 180 can control the video to be played in accordance with a trace information linked to the message registered by the 1st user. For instance, if a user input of touching a message registered by Jane or an indicator indicating a trace information of Jane is received, as shown in FIG. 12 (b), the controller 180 can control a video to be played in accordance with the trace information of Jane. In doing so, the controller 180 can control a trace bar 1210, which indicates the trace information of Jane, and a total play time information 1220, which indicates a total play time required in case of playing the video in accordance with the trace information of Jane, and the like to be outputted. Besides, a zooming information may be outputted onto the indicator [not shown in the drawing]. In particular, the zooming information may indicate a maximum zooming level or a minimum zooming level of a video in case of playing the video in accordance with a corresponding trace information. For example, when the video is played in accordance with the trace information of Jane, if a zooming level ranges between x1˜x2.5, a zooming information indicating ‘1˜2.5’ can be outputted onto the indicator.

If a user input of touching a message registered by a 2nd user or an indicator indicating a trace information of the 2nd user is received, the controller 180 can control a video to be played in accordance with a trace information linked to the message registered by the 2nd user. For instance, if a user input of touching a message registered by Tom or an indicator indicating a trace information of Tom is received, as shown in FIG. 12 (c), the controller 180 can control a video to be played in accordance with the trace information of Tom. In doing so, the controller 180 can control a trace bar 1230, which indicates the trace information of Tom, and a total play time information 1240, which indicates a total play time required in case of playing the video in accordance with the trace information of Tom, and the like to be outputted. Besides, a zooming information may be outputted onto the indicator [not shown in the drawing]. For example, when the video is played in accordance with the trace information of Tom, if a zooming level ranges between x0.7˜x1, a zooming information indicating ‘0.7˜1’ can be outputted onto the indicator.

While a video is played in accordance with a trace information registered by a specific person, if a user input of touching a video play screen or a user input for changing a position of a display region is received, the controller 180 may stop playing the video in accordance with the trace information.

A message registered at a post including a video may be outputted in a manner of overlaying the video. For example, based on a time information indicating a timing point to output a message and a position information indicating a position to output a message, the controller 180 can control the message to be outputted in a manner of overlaying a video. As mentioned in the foregoing description with reference to FIG. 7, a time information and a position information of a message can be determined in accordance with a message added timing point and a position of a display region on adding the message. Moreover, since the features in outputting a message by overlay based on time information and position information are already described with reference to FIG. 8, corresponding details shall be omitted from the following description.

While a video is played in accordance with a trace information linked to a message, if a user input for intending to add a new message is received, the controller 180 can make a request for registering a newly inputted message as a reply to the trace information linked message (i.e., a pre-registered message) to an SNS server.

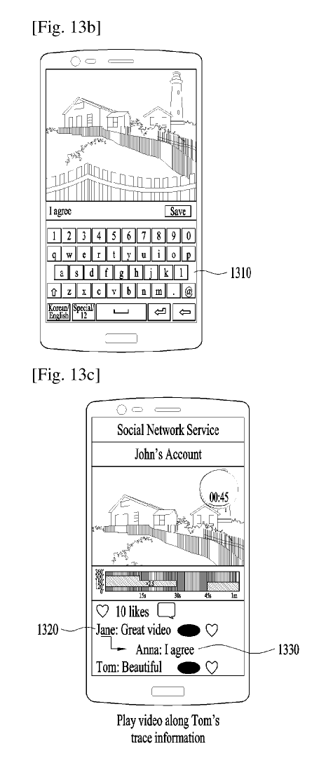

For instance, FIG. 13 is a diagram for one example of registering a reply.

First of all, for clarity of the description, assume that a video is played in accordance with a trace information linked to a message registered by Jane in FIG. 13 (a).

Referring to FIG. 13, while a video is played in accordance with a trace information linked to a prescribed message, if a new message is inputted and a user input for registering the inputted message is received, the controller 180 can make a request for registering the inputted message as a reply to the trace information linked message to an SNS server.

For example, while a video is played in accordance with a trace information of Jane [FIG. 13 (a)], if a user input for intending to input a message is received, the controller 180 can control an input device (e.g., IME) 1310, which is provided to input a message, to be outputted [FIG. 133 (b)]. After a text has been inputted through the input device 1310, if a user input for intending to register the inputted text at a post is received, like the example shown in FIG. 13 (c), the controller 180 can make a request for registering the inputted text as a reply 1330 to the message 1320 registered by Jane to the SNS server. In doing so, since the trace information of the video played in the mobile terminal is identical to a trace information linked to the message 1320 registered by Jane, the message registered as the reply 1330 may not have a trace information linked thereto.

Although a video play starts in accordance with a trace information linked to a prescribed message, if it is unable to further follow the trace information on the way, the controller 180 makes a request for registering a newly inputted message as a reply to the SNS server and is also able to make a request for linking a new trace information to the new message to the SNS server.

For example, although a video play starts in accordance with the trace information of Jane, if the trace information of Jane is not further followed in response to a user input, referring to FIG. 13 (c), the controller makes a request for registering a newly inputted message as a reply to the message registered by Jane and is also able to make a request for registering a newly applied trace information to the message registered as the reply to the SNS server.

If a plurality of trace information linked messages exist, it is difficult for a user to check a trace information of each of a plurality of the messages one by one. Hence, the controller 180 can request the SNS server to provide a message, to which a trace information meeting a prescribed condition is linked, by filtering.

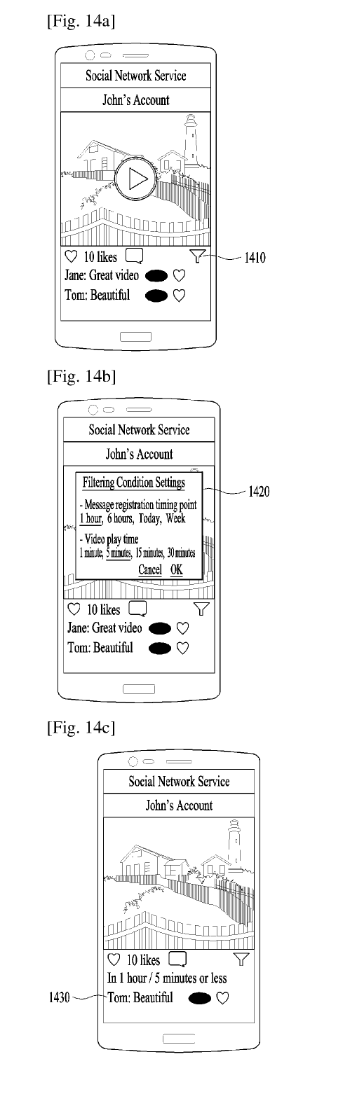

For instance, FIG. 14 is a diagram for one example of outputting a message list linked to a prescribed condition met trace information.

Referring to FIG. 14, if a prescribed user input (e.g., a touch input of touching a button 1410 for setting a filtering condition, which is shown in FIG. 14 (a)) is received, the controller 180 can control a menu window 1420 for setting filtering conditions to be outputted [FIG. 14 (b)].

In this case, the filtering conditions may indicate a message registered timing point, a time consumed for playing a video in accordance with a trace information, and the like. According to the example shown in FIG. 14 (b), the filtering conditions may be appreciated as indicating: i) a message should be registered in an hour; and ii) a time consumed for playing a video in accordance with a trace information should be equal to or less than 5 minutes. Besides, the controller 180 may set a preference for a message, an output timing point of a message, an output position of a message, or the like as one of the filtering conditions. The message preference shall be described in detail later.

An output timing point of a message indicates a timing point at which the message is outputted during a video play. For example, regarding the output timing point of the message, if a filtering condition is set to ‘in 5 minutes’, the controller 180 can filter a message that is to be outputted in 5 minutes since a video play start.

An output position of a message indicates a position to which the message is outputted during a video play. For example, regarding the output position of the message, if a filtering condition is set to ‘120°˜180° ’, the controller 180 can filter a message having an output position included in 120°˜180°.

A plurality of conditions included in the above-listed conditions may be simultaneously set as the filtering conditions. If so, the controller 180 may extract a message that meets a plurality of the filtering conditions.

The controller 180 may request the SNS server to filter a message that meets the filtering conditions. If information on a message meting the filtering conditions is received from the SNS server, like the example shown in FIG. 14 (c), the controller 180 can output a list of messages that meet the filtering conditions. According to the example shown in FIG. 14 (c), a message 1430 registered by Tom meets the filtering conditions when there are the message registered by Jane and the message registered by Tom.

In case that a plurality of messages are registered at a post, the controller 180 may control messages to be outputted in a manner of being sorted by a prescribed reference. For example, the controller 180 can control a plurality of messages to be outputted in a manner of being sorted by a message registered time order, a message preference order, or the like.

The controller 180 can control a message or an indicator to be identifiably displayed depending on whether a video is played in accordance with a trace information linked to the message.

For instance, FIG. 15 is a diagram for one example of identifiably displaying at least one of a message and an indicator.

Referring to FIG. 15, if a video is played in accordance with a trace information linked to a message, the controller 180 can control the message or an indicator to be identifiably displayed. In the example shown in FIG. 15, assume that a trace information linked to a message registered by Jane is already used and that a trace information linked to a message registered by Tom is unused yet. Like the example shown in FIG. 15, the controller 180 controls an indicator (i.e., Jane's indicator) 1510 corresponding to a previously used trace information to be outputted in a 1st color and is also able to control an indicator (i.e., Tom's indicator) 1520 corresponding to an unused trace information to be outputted in a 2nd color. Unlike the example shown in the drawing, the controller 180 skips an output of an indicator in case that a trace information linked to a message is already used. If the trace information linked to the message is unused yet, the controller 180 may control the indicator to keep being displayed.

Besides, the controller 180 may adjust a color of a message depending on whether a trace information is used already [not shown in the drawing].

The controller 180 may display a user preference information for a message registered at a post.

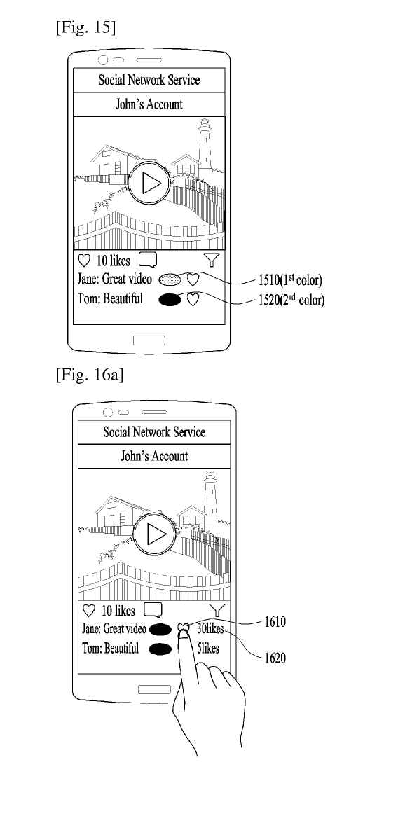

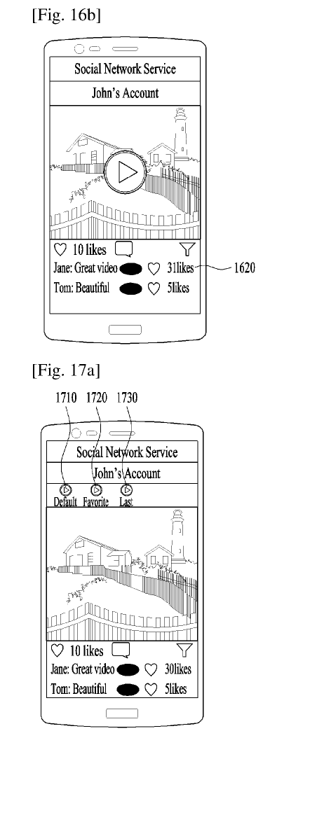

For instance, FIG. 16 is a diagram for one example of outputting preference information.

Referring to FIG. 16, if a user input for selecting a preferred message registered at a post is received, the controller 180 can request the SNS server to raise a preference of the selected message. Like the example shown in FIG. 16 (a), if a user input of touching a button 1610 indicating that a message is preferred is received, the controller 180 can request the SNS server to increment a preference count for the selected message.

For example, if a message (e.g., Jane's message) having a preference count 1620 set to 30 is selected [FIG. 16 (a)], the SNS server can increment the preference count 1620 into 31 in response to the request from the mobile terminal [FIG. 16 (b)].

Preference information can be utilized as a condition for filtering a message. For example, a message having a preference over a prescribed count may be set as one of filtering conditions, or an extraction of N messages in order of preference may be set as one of the filtering conditions.

Based on a trace information, the controller 180 can play a video. In particular, the controller 180 can control a video to be played in accordance with a trace information set by a video provider, a trace information linked to a message having a highest preference, a trace information applied on playing a video in the past, or the like. In this case, the trace information set by the video provider may mean a trace information previously set by the video provider, who made a video, in order for the video to be played in the future in accordance with a composition or subject recommended by the provider on making the video. A plurality of trace informations may be set by the video provider. For instance, in case of a video of recording a sports game, a video provider can provide a trace information for tracing a specific person, a trace information for tracing a ball, and the like. For another instance, in case of a video of filming a plurality of members who were singing, a video provider may provide a plurality of trace informations for tracing a plurality of the members, respectively. Yet, for an embodiment described in the following, assume that a video provider a single trace information. In case that a video provider provides a plurality of trace informations, in a following drawing, in order to play a video in accordance with a trace information provided by the video provider, it can be apparently appreciated that a plurality of buttons can be outputted.

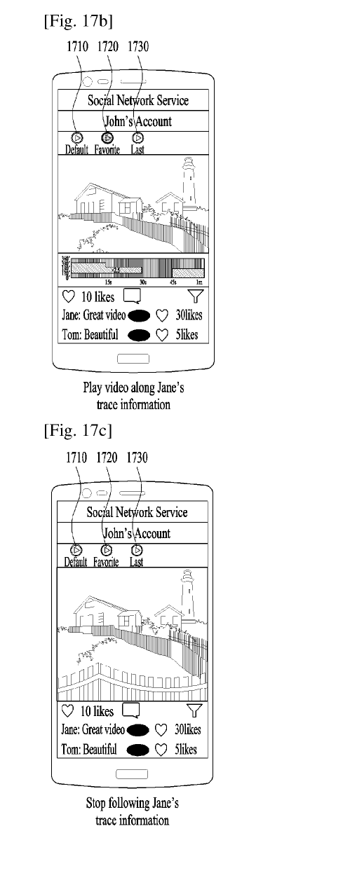

For instance, FIG. 17 is a diagram for one example of playing a video according to trace information. In case of intending to display a post including a video, the controller 180 can control at least one trace button, which is provided to trigger a video play in accordance with a trace information, to be outputted. In particular, FIG. 17 (a) shows one example that 3 trace buttons 1710, 1720 and 1730 are outputted.

Among the trace buttons shown in FIG. 17 (a), the 1st trace button 1710 may be configured to play a video in accordance with a trace information set by a video provider, the 2nd trace button 1720 may be configured to play a video in accordance with a trace information linked to a message having a highest preference, and the 3rd trace button 1730 may be configured to play a video in accordance with a trace information previously applied on playing a video in the past.

If a user input of touching one of the trace buttons is received, the controller 180 can play a video in accordance with a trace information corresponding to the selected button. For example, in case of receiving a user input of touching the 2nd trace button 1720, the controller 180 can control a video to be played in accordance with a trace information linked to a message having a highest preference. When Jane's message and Tom's message are already registered at a post, if a preference count for the Jane's message is 30 and a preference count for the Tom's message is 5, the controller 180 may play a video in accordance with a trace information linked to the Jane's message in response to a user input of touching the 2nd trace button 1720.

As a prescribed trace button is selected, while a video is played in accordance with a trace information corresponding to the selected button, if a user input of reselecting the prescribed trace button is received, the controller 180 may control the video not to further follow the trace information. For example, while a video is played in accordance with a trace information corresponding to the 2nd trace button 1720, if a touch input of touching the 2nd trace button 1720 is received, like the example shown in FIG. 17 (c), the controller 180 maintains a play timing point of the video and is able to control the trace information corresponding to the 2nd trace button 1720 not to be further follows.

While a video is played in accordance with a trace information corresponding to a prescribed trace button, if a user input of touching a different trace button is received, the controller 180 stops playing the video in accordance with the existing trace information and is also able to control the video to be played in accordance with a new trace information corresponding to the newly selected trace button.

For example, while a video is played in accordance with a trace button corresponding to the 2nd trace button 1720, if a touch input of touching the 1st trace button 1710 is received, the controller 180 stops flowing the trace information corresponding to the 2nd trace button 1720 and is able to control a trace information corresponding to the 1st trace button 1710 to be followed. In doing so, the controller 180 maintains a play timing point of the video on touching the 1st trace button 1710 and is also able to control the video to be played in accordance with the trace information corresponding to the 1st trace button 1710. Alternatively, the controller 180 plays the video from the beginning again and is also able to control the video to be played in accordance with the trace information corresponding to the 1st trace button 1710.

While a video is played in accordance with a trace information, if a user input for intending to change a position of a display region is received, the controller 180 can control the position of the display region to be changed. Hence, if the position of the display region at a current play timing point becomes different from the position of the display region indicated by the trace information at the current play timing point, the controller 180 can control a feedback, which indicates that the position of the display region fails to further follow the trace information, to be outputted.

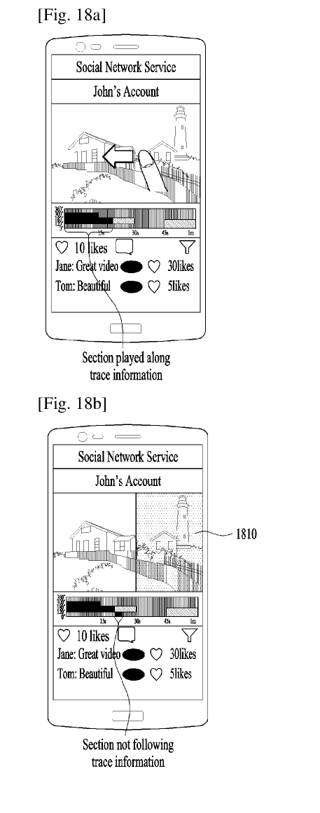

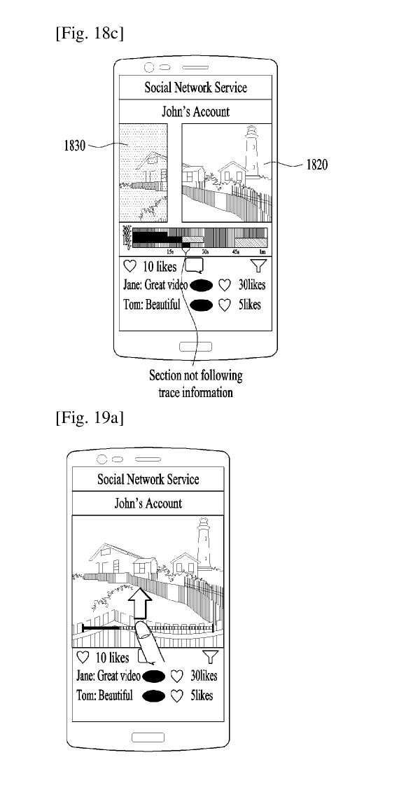

For instance, FIG. 18 is a diagram for one example of outputting a feedback.

Referring to FIG. 18, while a video is played in accordance with a trace information, if a user input for intending to change a position of a display region is received, the controller 180 can change the position of the display region. For example, like the example shown in FIG. 18 (a), if a user input of dragging to move a pointer in a prescribed direction is received, the controller 180 can control a position of a display region to be shifted in a drag moving direction of the pointer or a direction opposite to the drag moving direction of the pointer.

In doing so, the controller 180 can control a feedback, which indicates that the position of the display region has deviated from the position of the display region indicated by the trace information, to be outputted. For example, if a current display region overlaps a display region indicated by a trace information in part, like the example shown in FIG. 18 (b), the controller 180 can control a part 1810 of the current display region, which does not overlap the display region indicated by the trace information, to be identifiably displayed. In particular, as a position of a display region is changed, the controller 180 can control a newly outputted region to be displayed visually and identifiably by deviating from a trace region.

For another instance, like the example shown in FIG. 18 (c), the controller 180 displays both a current display region 1820 and a display region indicated by a trace information and may be also able to control a part of the display region indicated by the trace information, which is outputted through a region 1830 failing to overlap the current display region, to be identifiably displayed.

While a video is played, the controller 180 can output a trace information. In doing so, the controller 180 can control both a currently applied trace information and a recommended trace information applicable to a video play to be simultaneously outputted.

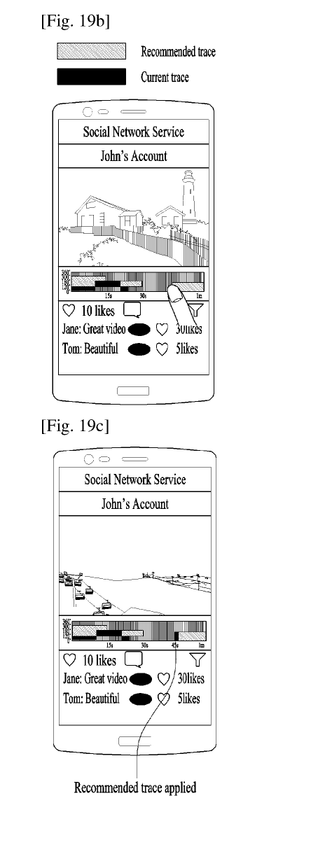

For instance, FIG. 19 is a diagram for one example of outputting trace information.

Referring to FIG. 19, while a video is played, if a prescribed user input is received, the controller 180 can control a trace bar to be outputted. For example, if a user input of dragging to move a pointer currently touching a progress bar in a prescribed direction is received [FIG. 19 (a)], the controller 180 can control a trace bar to be outputted [FIG. 19 (b)].

Through the trace bar, the controller 180 can control a currently applied trace information and a recommended trace information to be outputted. According to the example shown in FIG. 19 (b), the currently applied trace information is outputted in a manner of overlaying the recommended trace information.

In doing so, if a user input of touching a specific timing point on the trace bar is received, the controller 180 can control the video to be played in accordance with the recommended trace information. For example, if a user input of touching a play timing point of 45 seconds is received [FIG. 19 (b)], the controller 180 can control the video to be played from an interval having a play timing point set to 45 seconds in accordance with the recommended trace information [FIG. 19 (c)].

In this case, the recommended trace information may include one of a trace information set by a video provider and a trace information linked to a message having a highest preference.

In case that a position of a display region is different from that of a display region indicated by a trace information, the controller 180 can control a message, which is provided to guide the position of the display region to the position of the display region indicated by the trace information, to be outputted.

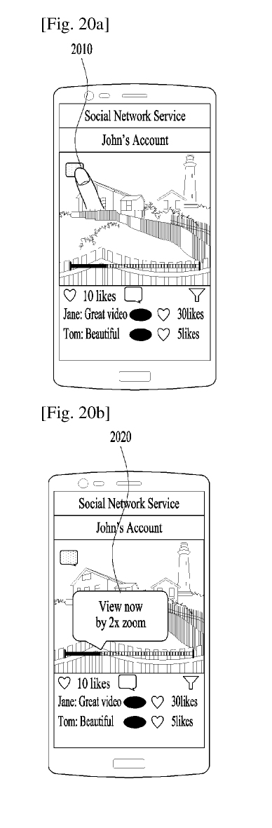

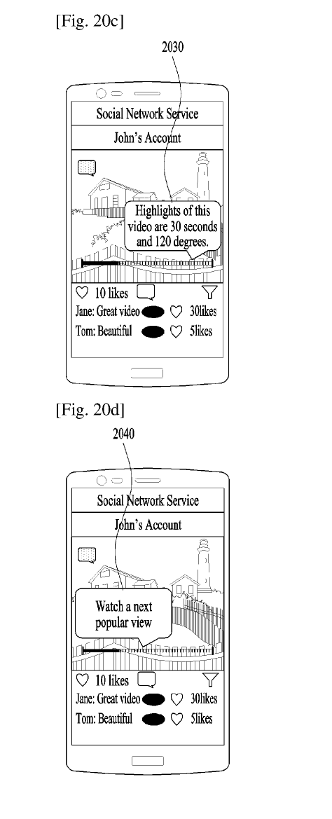

For instance, FIG. 20 is a diagram for one example of outputting a message.

Referring to FIG. 20, while a video is played, if a prescribed user input is received, the controller 180 can control a message, which is provided to guide a position of a current display region to a position of a display region indicated by a trace information, to be outputted.

For example, if a touch input of touching a button for requesting a message output is received [FIG. 20 (a)], the controller 180 can control a message 2101, which informs a user of an action supposed to be taken to change into a position of a display region indicated by a trace information, to be outputted [FIG. 20 (b)]. According to the example shown in FIG. 20 (b), outputted above a progress bar is a message 2020 for requesting to change the display region increasingly through zoom-in.

If a touch input of touching the message is received, the controller 180 can control the display region to be adjusted as guided by the message. For example, if a user input of touching the message 2020 shown in FIG. 20 (b) is received, the controller 180 can zoom in on the video by 2x in a manner guided by the message.

The controller 180 may output a message 2030 indicating a most popular section in a whole play section of a video and a position of a display region in the corresponding section.

For example, FIG. 20 (c) shows that a message 2030 indicating a most popular play section and a position of a display region in the corresponding section is outputted above the progress bar. If a touch input of touching the message is received, the controller 180 shifts a play timing point of the video to a play section indicated by the message and is also able to set a position of a display region in a manner as guided by the message 2030. For example, if the message 2030 shown in FIG. 20 (c) is touched, the controller 180 changes a play timing point of the video into 30 seconds and may be also able to control the display region to be situated at a point having a rotating angle set to 120°.

If a video is played in accordance with a prescribed trace information, the controller 180 may output a message 2040 for guiding a use of another trace information.

For example, if a video is currently played in accordance with a trace information having a highest preference, referring to FIG. 20 (d), the controller 180 can control a message, which guides to play the video in accordance with a trace information having a preference in next order, to be outputted. If a touch input of touching the message is received, the controller 180 can play the video in accordance with the trace information guided by the message. For example, if the message 2040 shown in FIG. 20 (d) is touched, the controller 180 stops following the trace information having the highest trace information and may be then able to play the video in accordance with the trace information having a second highest preference.

While a message is outputted, if a user input of touching a message button 2010 is received, the controller 180 may stop outputting the message.

The controller 180 can automatically adjust a position of a display region centering on a prescribed subject included in a video.

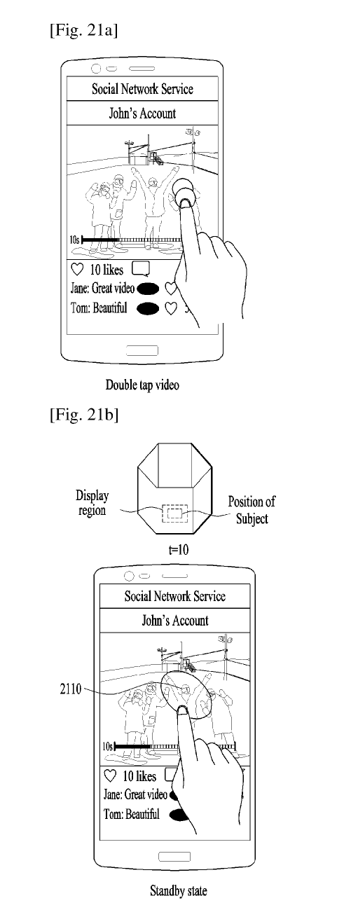

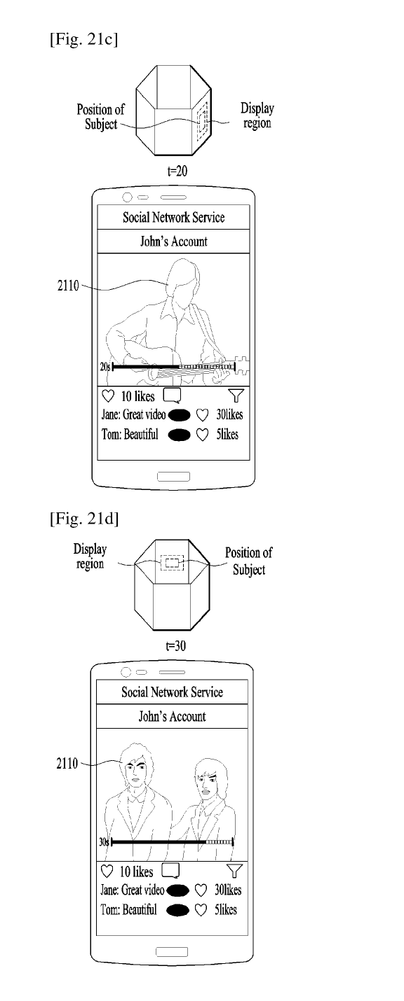

For instance, FIG. 21 is a diagram for one example of automatically adjusting a position of a display region centering on a prescribed subject. If a prescribed user input is received during a video play, the controller 180 stops the video play and is able to maintain a standby state until selecting a subject included in the video. According to the example shown in FIG. 21 (a) and FIG. 21 (b), as a touch input of touching a currently played video twice with a pointer is received, the mobile terminal enters a standby state.

Thereafter, if a user input for selecting a prescribed subject 2110 included in the video is received, the controller 180 resumes the video play and is also able to control a position of a display region to be automatically adjusted centering on the selected subject 2110. Like the example shown in FIG. 21 (b), if a drag input for drawing a trace of enclosing the subject 2110 is received, the controller 180 can control the display region to move in pursuit of the corresponding subject 2110.

For example, referring to FIG. 21 (c) and FIG. 21 (d), a position of a display region is automatically adjusted in accordance with a position of the subject 2110.

While a video is played along a prescribed subject, if a message is inputted, the controller 180 may configure an indicator, which indicates that a trace information linked to the message exists, based on an image of the subject. Although FIG. 11 shows that the indicator 1160 has an elliptical shape, if a message is inputted during a video play along a prescribed person, an image of the prescribed person may be utilized as an indicator.

The controller 180 may request to raise a preference for a subject included in a video.

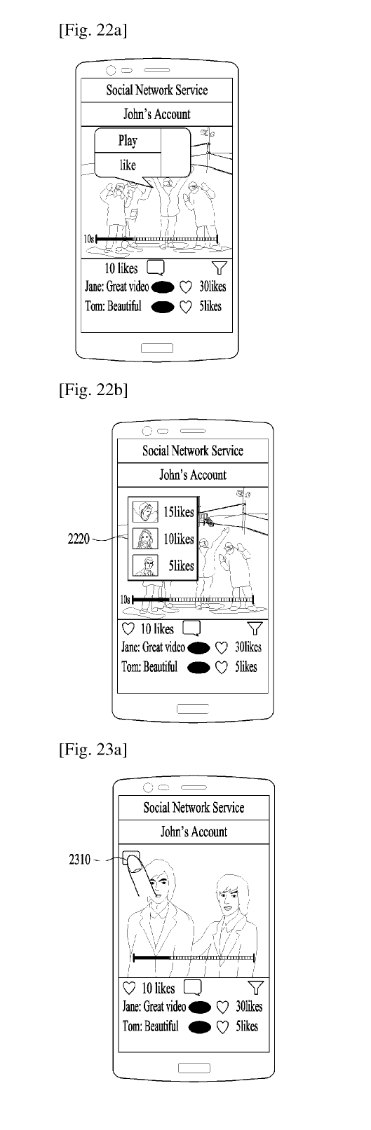

For instance, FIG. 22 is a diagram for one example of raising a preference for a subject included in a video.

Referring to FIG. 22 (a), while a video is played, if a user input for selecting a subject included in the video is received, the controller 180 can output a menu 2210 related to the selected subject. Through the menu 2010, a user may control the video to be played along the selected subject or may raise a preference for the selected subject.

For example, in the menu 2210 shown in FIG. 22 (a), an item ‘play’ may be provided to automatically adjust a position of a display region in pursuit of the selected subject and an item ‘like’ may be provided to raise a preference of the selected subject.

According to the example shown in FIG. 22 (a), if the item ‘like’ is selected, the controller 180 may request the SNS server to raise a preference count for the selected subject.

The controller 180 may output an information on a preference count per subject included in the video. According to the example shown in FIG. 22 (b), a list 2220, which indicates a preference count per subject included in the video, is outputted in a manner of overlaying the video.

If a prescribed item is selected from the list 2220 shown in FIG. 22 (b), the controller 180 can control the video to be played along a subject corresponding to the selected item.

After a user input for indicating that a prescribed subject is preferred has been received, if a message is inputted, the controller 180 can configure an indicator, which indicates that a trace information linked to the message exists, based on an image of the subject selected as preferred by a user.

While a video is played, the controller 180 can control a message, which indicates a subject observed closely by users, to be outputted.

For instance, FIG. 23 is a diagram for one example of outputting a message.

Referring to FIG. 23, while a video is played, if a prescribed user input is received, the controller 180 can control a message, which is provided to indicate a popular subject in the video, to be outputted.

For example, if a touch input of touching a button 2310 for requesting a message output is received [FIG. 23 (a)], the controller 180 can control a message 2320, which is provided to indicate a popular subject, to be outputted [FIG. 23 (b)]. In this case, the popular subject may mean a subject having a highest preference count, a subject along which the video has been most frequently played, or the like.

If a touch input of touching the message is received, the controller 180 can control a position of a display region to be automatically changed along the subject indicated by the message 2320.

In case of intending to stream to play a video, the controller 180 can preferentially apply a trace information of a sharer who shares the video. The reason for this is to provide a user with the same experience of the video sharer.

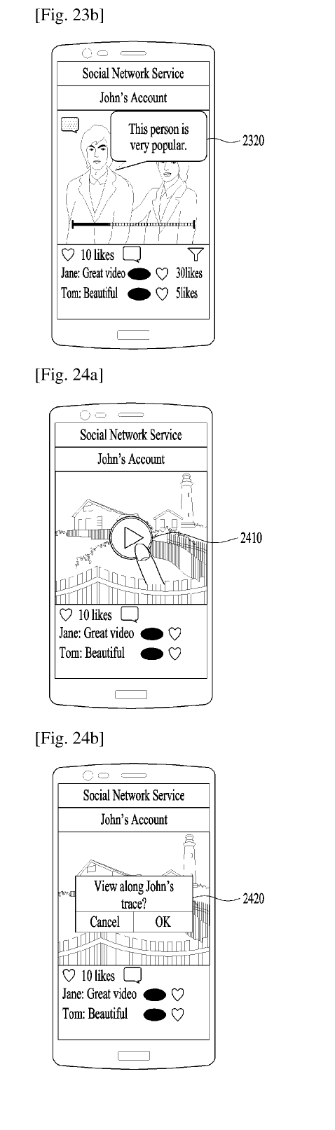

For instance, FIG. 24 is a diagram for one example of preferentially applying trace information of a video sharer.

Referring to FIG. 24, if a user input for triggering a play of a video intended to be played by streaming is received (e.g., a touch input of touching a play button 2410 is received) [FIG. 24 (a)], the controller 180 can control a menu 2420, which is provided to determine whether to play the video in accordance with a trace information of a sharer sharing the video, to be outputted [FIG. 24 (b)]. According to the example shown in FIG. 24 (a), if a person sharing a video is John, the controller 180 can output a menu 2420 for querying whether to play the video in accordance with a trace information of John.

Based on a user input to the menu 2420, the controller 180 can play the video in accordance with the trace information of the sharer.

After a video has been fully played along a trace information having a highest preference, the controller 180 may play the video in accordance with a trace information having a second highest preference.

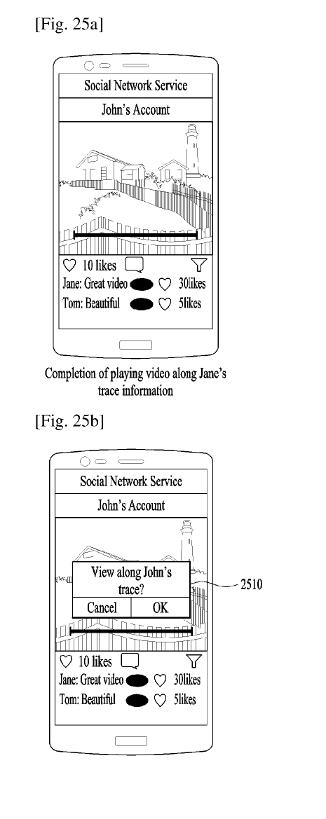

For instance, FIG. 25 is a diagram for one example of applying trace information having a next ordered preference.

Referring to FIG. 25, if playing a video along a trace information having a highest preference is ended [FIG. 25 (a)], the controller 180 can control a menu 2510, which is provided to determine whether to apply a trace information having a second highest preference, to be outputted [FIG. 25 (b)]. For example, if a trace information having a highest preference is Jane's information and a trace information having a second highest preference is Tom's information, after playing the video in accordance with the trace information of Jane is ended, the controller 180 can control a message, which is provided to query whether to play the video in accordance with the trace information of Tom, to be outputted.

Based on a user input to the menu 2510, the controller 180 can play the video in accordance with the trace information having the second highest preference.

The present invention can provide a mobile terminal and controlling method thereof, by which user convenience can be enhanced.

In particular, the present invention can provide a mobile terminal and controlling method thereof, by which a position of a display region of a video can be automatically adjusted in accordance with trace information.

And, the present invention can provide a mobile terminal and controlling method thereof, by which users are guided to acquire similar experiences by sharing trace information with each other.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments. As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

### INDUSTRIAL APPLICABILITY

The invention has industrial applicability in a field related to a mobile terminal and a control method thereof.

1. A mobile terminal comprising:
a wireless communication unit that receives data for playing a video;
a display unit that displays the video; and
a controller that adjusts the position of a display region of the video in accordance with trace information indicating the position of the display region as a function of the play timing point of the video.

2. The mobile terminal of claim 1, wherein the controller controls a trace bar for visualizing the trace information.

3. The mobile terminal of claim 2, wherein the trace bar further comprises a first axis and a second axis, wherein the first axis corresponds to the play timing point of the video and wherein the second axis corresponds to an angle of the display region.

4. The mobile terminal of claim 2, wherein the controller controls the display unit to output zooming information with the trace bar, the zooming information indicating a zooming level of the video as a function of the play timing point of the video.

5. The mobile terminal of claim 1, wherein when the video is played, the controller stops adjusting the position of the display region in response to a prescribed user input.

6. The mobile terminal of claim 5, wherein if a position of a current display region is different from the position of the display region indicated by the trace information, the controller shifts the position of the current display region to the position of the display region indicated by the trace information.

7. The mobile terminal of claim 5, wherein if a user input message is associated with the trace information and if a position of a current display region does not include the position of the display region indicated by the trace information, the controller outputs a message indicator at the position of the current display region.

8. The mobile terminal of claim 7, wherein if the controller determines that a user has applied a touch input to the display unit over the message indicator, the controller shifts the position of the current display region to the position of the display region indicated by the trace information.

9. The mobile terminal of claim 1, wherein the controller controls an indicator corresponding to a whole display region of the video and wherein the controller controls an object corresponding to the position of the display region on the indicator.

10. The mobile terminal of claim 9, wherein the controller controls a time line bar indicating the current play timing point of the video and wherein the time line bar is configured to enclose the indicator.

11. The mobile terminal of claim 9, wherein if the trace information is set to follow a subject included in the video, the controller controls the display unit to display the indicator using an image of the subject.

12. The mobile terminal of claim 1, wherein the trace information is linked to a message associated with the video.

13. The mobile terminal of claim 12, wherein when the video is played, the controller registers a subsequently received user text as a reply to the message linked to the trace information.

14. The mobile terminal of claim 12, wherein output timing point information of the message and position information of the message are set, and if the play timing point of the video is prior to expiration of the time indicated by the output timing point information and if the position of the display region includes the position information, the controller overlays the message with the video.

15. A method of controlling a mobile terminal, the method comprising:
receiving data for playing a video and displaying trace information indicating a position of a display region as a function of the play timing point of the video;
outputting the video through a display unit; and
adjusting the position of the display region of the video in accordance with the trace information.
